(19) United States
(12) Patent Application Publication
(10) Pub. No.: US 2002/0095322 A1
(43) Pub. Date: Jul. 18, 2002

(54) System and method of monitoring supply chain parameters

(75) Inventor: Kurt A. Zarefoss, Middletown, MD (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Manugistics, Inc., Rockville, MD

(21) Appl. No.: 09/984,340

(22) Filed: Oct. 29, 2001

Related U.S. Application Data
(60) Provisional application No. 60/243,343, filed on Oct. 27, 2000.

(51) Int. Cl. G06F 17/60

(52) U.S. Cl. 705/7

(57) ABSTRACT

The invention provides a system and method for supply chain management by monitoring queried factors, or business variables, by providing the ability to create customized business rules that monitor specific performance indicators. The invention also provides a system whereby electronic alert messages provide notifications if the customized business rules are changed or violated. The system further provides a central user interface that alerts subscribers in real-time to business rules violations and allows subscribers to resolve these violations. Finally, the invention provides a method for monitoring supply chain management variables that includes the steps of establishing a business rule, executing the business rule, generating exception notifications for violations of the business rule, and sending the exception notifications to authorized subscribers.

### CROSS REFERENCE TO RELATED APPLICATIONS

This application claims priority from U.S. Provisional Patent Application Serial No. 60/243,343, filed Oct. 27, 2000, the disclosure of which is hereby incorporated by reference in its entirety.

### FIELD OF THE INVENTION

The present invention relates to a system and method for inventory management and control. More specifically, the invention provides a system for supply chain management through the monitoring of performance indicators to determine whether a violation has occurred in pre-defined custom business rules and enterprise targets.

### BACKGROUND OF THE INVENTION

Within the modern economy, the supply of goods and products is increasingly critical to the success of an organization. For example, businesses that operate on the Internet typically must transport goods to customers with every order. For these Internet businesses, product supply is not merely a simple business function that must be managed, but rather a strategic function that influences revenue generation and customer satisfaction. More specifically, a business having relatively higher inventory costs and/or relatively slower or less reliable delivery of their products and goods is at a severe competitive disadvantage.

Accordingly, many organizations devote a high level of logistic resources to supply chain management of their goods and products. For example, depending on the industry in which an organization competes, the management of supply-chain factors may account for up to half of the organization's total logistics cost. A supply chain is typically a reticulated network of people and organizations interacting dynamically to supply and sell their products and services.

Adding to the difficulty of managing supply chain factors is the complex relationship between trading partners, which is often adversarial. A trading partner may be a supplier, customer, subsidiary, or any other organization or persons that participates in the same supply chain or trading network.

Given the immense importance of supply chain factors to the overall health of an organization, organizations have understandably attempted to develop a variety of techniques for monitoring the myriad of parameters involved in their supply chain functions. Most of the conventional monitoring techniques require substantial human involvement to monitor every step from production to product delivery. Unfortunately, due to the reliance on human intervention, if predetermined requirements are violated, a person in the organization must be notified to ensure that necessary changes to the supply change are effected.

The ability to respond quickly and efficiently to problems in supply chain management is necessary for an organization's survival in today's dynamic global marketplace. Minimizing an organization's response time to supply chain problems allows the organization to promptly enact appropriate adjustments to avoid adverse results.

Problems often occur in supply chain management for a variety of reasons. For example, supply chain participants may have logistically impeding legal commitments, manufacturers may require lag times to make remedial changes to production quantities, inventory space may be limited, etc. To overcome such problems, supply chain participants may require increased synergy, often based on business forecasts that attempt to predict future business indicators.

Developing reliable forecasts that maximize participant synergy, however, requires information that is current and accurate. Unfortunately, it is often very difficult for supply chain trading partners to obtain relevant and accurate information on a timely basis. For example, conventional supply chain monitoring techniques above are often too slow to respond adequately to adverse changes in supply chain parameters. The delay in responding to adverse changes may largely be attributable to the extensive human involvement in conventional systems, which leads to delays in detecting changes in the supply chain or to inadequate communication with other supply chain participants. These delays are a direct consequence of the need for human notification and interaction to remedy supply chain concerns.

The inability of trading participants to share information is exacerbated by the fact that businesses often use different management systems. As a result, relevant information is often unavailable simply because there is no system for sharing information among supply chain participants.

Further increasing the difficulties inherent in managing supply chain parameters is the general dynamic nature of supply chains. Supply chains are typically a complex network of organizations that is constantly evolving. Participants may need to be included and excluded as business relationships constantly realign themselves. Although the ability to include, or exclude, supply chain participants brings great flexibility, it dramatically increases the difficulties of providing each participant with necessary, relevant information on a real-time basis.

Thus, a system that overcomes the deficiencies in the current supply chain monitoring methodologies is desirable. In particular, an automated system that monitors a supply chain, establishes appropriate business rules, monitors whether those business rules are met or violated and provides real-time notices to those participants designated to receive them would be highly desirable. Such a system will dramatically improve supply chain efficiency, allowing for better-on time delivery, increased response time, shorter fulfillment time, less inventory investment, higher productivity per employee, improvement in cash-to-cash cycle time and fewer investments in material acquisition.

### SUMMARY OF THE INVENTION

In order to overcome the deficiencies in the existing supply chain monitoring methodologies described above, the invention provides a method and system for supply chain monitoring by providing the ability to create customized business rules that monitor specific performance indicators. The invention also provides a system whereby electronic alert messages provide notifications if the customized business rules are changed or violated. The system further provides a central user interface that alerts subscribers in real-time to business rule violations and allows subscribers to resolve these violations.

The system according to the invention may be accessible over any network, including the Internet and provides an open architecture enabling any business or organization to seamlessly integrate with its functionality.

Therefore, it is an object of the invention to provide a system and method for monitoring supply chain parameters.

It is a further object of the invention to provide a system and method for establishing supply chain business rules and monitoring violations of those business rules.

It is a further object of the invention to provide a system and method for providing real-time notifications when supply chain business rules are violated or monitored events occur.

In order to carry out these and other objectives, the invention provides a method for monitoring supply chain management variables that includes the steps of establishing a business rule, executing the business rule, generating exception notifications for violations of the business rule, and sending the exception notifications to subscribers.

The invention further provides a system for monitoring supply chain management that includes at least one user that establishes a business rule, a monitoring system server in communication with the user, the monitoring system server monitoring the supply chain parameters in accordance with the business rule and sending an exception notification to authorized subscribers if a violation of the business rule occurs.

### BRIEF DESCRIPTION OF THE DRAWINGS

These and other advantages of the present invention are more fully described in the following drawings and accompanying text in which like reference numbers represent corresponding elements throughout:

FIG. 1 illustrates a block diagram of the supply chain monitoring system in accordance with an embodiment of the invention;

FIG. 2 is a flowchart illustrating the process for a monitoring supply chain parameters in accordance with an embodiment of the invention;

FIGS. 3a-f is a flowchart illustrating a process for exception generation and notification in accordance with an embodiment of the invention;

FIGS. 4a-c illustrate an exemplary record of data fields for a comparison business rule in accordance with an embodiment of the invention;

FIG. 5 illustrates an exemplary record of data fields for an attribute change business rule in accordance with an embodiment of the invention;

FIG. 6 illustrates an exemplary record of data fields for a component change business rule in accordance with an embodiment of the invention;

FIG. 7 illustrates an exemplary record of data fields for a component publish business rule in accordance with an embodiment of the invention;

FIG. 8 illustrates an exemplary record of data fields for a planning item change business rule in accordance with an embodiment of the invention;

FIG. 9 illustrates an exemplary record of data fields for a planning item assignment/unassignment business rule in accordance with an embodiment of the invention; and

FIG. 10 illustrates an exemplary record of data fields for market activity changed business rule.

### DETAILED DESCRIPTION OF THE PREFERRED EMBODIMENTS

The invention disclosed herein incorporates by reference the subject matter of co-pending and commonly assigned U.S. Non-Provisional Patent Applications “System and Method for Optimizing Resource Plans,” Shekar et al., Attorney Docket No. 82001-0198, filed Oct. 29, 2001; and “System and Method for Supply Chain Management, Including Collaboration,” Zarefoss et al., Attorney Docket No. 82001-0189, filed Oct. 1, 2001.

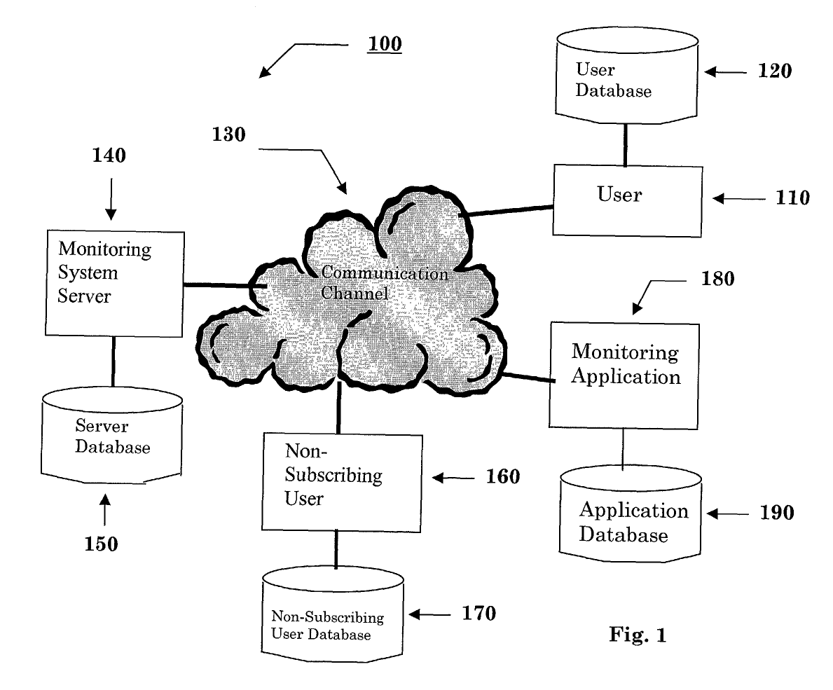

As shown in FIG. 1, the supply chain monitoring system 100 provides a system for monitoring supply chain parameters and for providing real-time notice to qualified subscribers that a business rule has been either changed or violated. FIG. 1 shows a monitoring system server 140 communicatively coupled to one or more users 110, one or more non-subscribing users 160, and one or more monitoring applications 180, via a communication channel 130. The communication channel 130 may be any medium or network through which communications may take place, such as but not limited to the Internet, intranet, Plain-Old-Telephone-Service (“POTS”), terrestrial connections, wireless channels and satellites. Each user 110 may be communicatively coupled to a user database 120. Similarly, the non-subscribing entity 160 may be communicatively coupled to a non-subscribing entity database 170, the monitoring system server 140 may be communicatively coupled to a monitoring system server database 150, and the monitoring application 180 may be communicatively coupled to a monitoring application database 190.

In operation, the user 110 may create a business rule by establishing the parameters, or attributes, of the business rule and communicating the business rule, and its associated parameters to the monitoring system server 140 via the communication channel 130. A business rule is an application that establishes the criteria to be used with user-defined parameters to determine whether an exception notice should be generated. Exception notices are generated when either violations to the business rule or triggering events defined by the rule have occurred. A violation of the business rule may occur when a particular item, i.e., a supply chain parameter, does not conform to a pre-defined business requirement. For example, if the inventory of a particular product falls below a threshold level, an exception notice may be generated. Furthermore, a triggering event may occur when an event occurs for which the business rule requested the monitoring system server 140 to monitor or observe. For example, the business rule may request the monitoring system server 140 to generate an exception notification whenever a specific retail promotion is changed.

The business rule application may be pre-defined and reside in the monitoring system server 140 and/or the monitoring system server database 150 at the time the user 110 requests execution of the business rule. Alternatively, the business rule application may be conceived and coded by a third-party entity, and then communicated to the monitoring system server 140, through a software plug-in or any other appropriate application capable of interfacing to the monitoring system server 140, prior to execution of the business rule. The monitoring system server 140 is able to execute the business rule after receiving, from the user, the parameters that define the rule.

The monitoring system server 140 may then initiate an observation of the data stored in the monitoring system server database or may request that the monitoring application 180 initiate an observation of the data stored in the application database 190, user database 120 and/or the non-subscriber entity database 170. In the first case, the monitoring system server 140 will generate the business rule exceptions, in the latter case, the monitoring application 180 will generate the business rule exceptions and then send the list of exceptions to the monitoring application 180 for further processing. In both cases, the monitoring system server 140 is responsible for sending the exception notifications to authorized users. The process of exception generation and notification will be discussed in greater detail below.

The user 110 may be a warehouse, a factory, a retailer, or any other supply chain participant that has been given permission to receive an exception notification of a violation for a specific business rule. Similarly, a non-subscribing entity 160 also may be a warehouse, a factory, a retailer, or any other supply chain participant. Unlike the user 110, however, the non-subscribing entity 160 is an entity that has not been granted permission to receive an exception notification for the violation of a specific business rule.

Permission to receive an exception notification may be granted to a user when it subscribes to a business rule. A user 110 may be subscribed to a business rule during the creation of the business rule if the entity creating the business rule includes the name of the user 110 as an authorized subscriber or if the user 110 is the entity that created the business rule. The user 110 that creates a business rule is known as the owner of the rule and is initially subscribed to that business rule. Additionally, the user 110 may be subscribed to the business rule if the user 110 requests the monitoring system server 140 to include the user's 110 name in the subscription list for the rule, and the server 140 grants the request. A business rule subscription list is maintained in the monitoring system server 140 and/or the monitoring system server database 150 for each business rule and lists the names of each user that is subscribed to that specific rule.

The user may also be granted permission to receive an exception notification if the user's e-mail address is included as an attribute of an item for which the exception notification was generated or if the attribute is later amended to include the user's e-mail address as an attribute. In either case, once the user 110 is granted such permission, the monitoring system server 140 will send the user 110 an exception notification for violations of each business rule that the user 110 has been granted permission to review.

The execution of a business rule may cause the monitoring system server 140 to monitor, and generate exception notifications for, a variety of circumstances and events. For example, the monitoring system server 140 may execute a business rule by comparing supply chain parameters of two users 110, of a user 110 and a non-subscribing entity 160, and/or of two non-subscribing entities 160. In such an example, the monitoring system server 140 could determine whether a violation of the business rule has occurred by examining the supply chain parameters (also called attributes), e.g., inventory, sales orders, etc, stored in the user database 120 and non-subscribing entity database 170. If the business rule is violated, the monitoring system server 140 will send an exception notification to each user 110 that is eligible to receive notification of the violation. The user 110 then takes remedial measures to correct the violation and sends the updated values of its supply chain attributes to the monitoring system server 140, which stores these values in its local database 150.

The user 110 may obtain, or select permission to receive, notifications for violations of any number of business rules. Thus, to receive an exception notification, a user 110 should either request permission to receive the notification, be on the subscriber list defined during the creation of the business rule, or be the owner of the business rule, i.e., the user 110 that created the business rule. An owner of the business rule is initially granted permission to receive exception notifications specific to that business rule and may also add or delete users 110 from the business rule's subscription list. Additionally, the permissions that are granted to a user 110 in the definition of the business rule affect the amount and type of data that the user 110 may view.

The user 110 may view business rule exceptions from e-mail or any platform capable of executing the monitoring system in accordance with the invention. To ensure that the user 110 that generated a business rule receives exception notification of a violation, the user 110 may require in the definition of the business rule that the subscriber user be sent an e-mail whenever a violation of the business rule occurs. Thus, a user 110 subscribing to a particular business rule may receive a notification of a business rule violation by e-mail from the monitoring system server 160. In accordance with an embodiment of the invention, the user 110 should have appropriate role permissions to create, update, delete, or copy business rules.

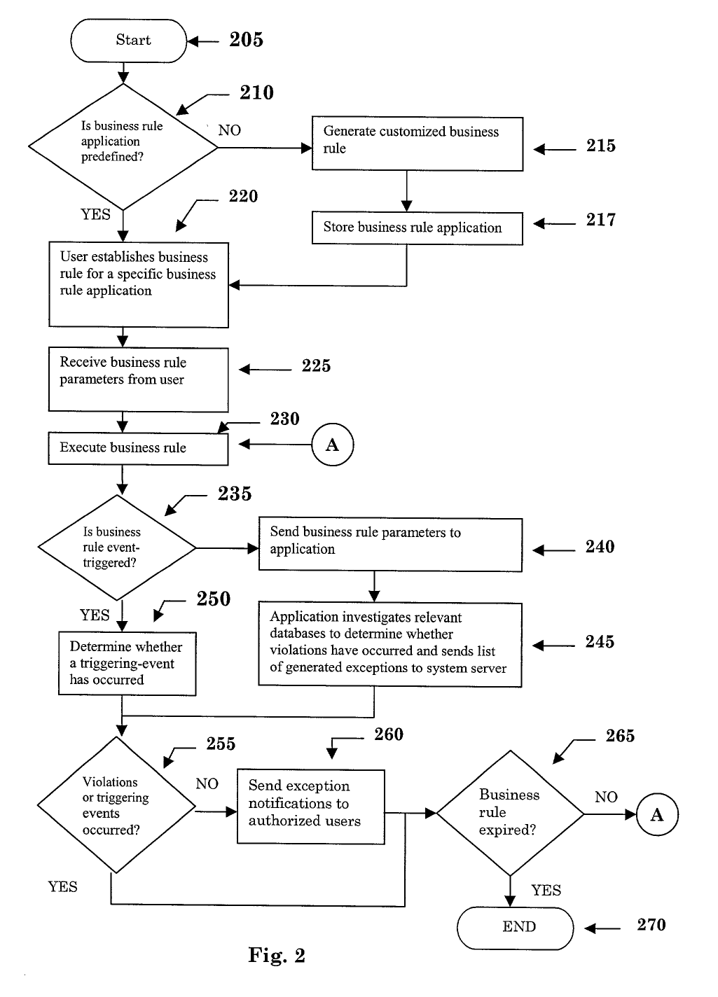

FIG. 2 illustrates the process for monitoring supply chain parameters in accordance with one embodiment of the invention. The process begins at step 205. In step 210, the system determines whether the business rule application that defines the business rule is pre-defined. A business rule application is the platform that supports a business rule and may contain a set of instructions that tells the monitoring system server 140 how to execute the business rule. That is, the business rule application is the software or hardware program that defines how the system server should execute a particular type of business rule. If the business rule application is pre-defined, then the application has previously been loaded and stored onto the system server and/or the system server database. As such, the system server recognizes requests for the predefined business rule type, and knows how to execute the underlying business rule accordingly. If the business rule application is pre-defined, i.e. has been previously communicated to the system server, the process moves to step 220, otherwise the process moves to step 215.

In step 215, the system server receives the business rule application from an entity that has previously conceived and coded the business rule application. After coding a business rule application, an entity may communicate the application to the system server, via a communication channel, through the use of a software plug-in, or any other module that allows external software or hardware code to be downloaded to the system server. After receiving the code for the business rule application, the system server stores the application in memory and/or its associated database in step 217. The process then moves to step 220.

In step 220, the user establishes a business rule. A user establishes a business rule by defining the parameters associated with the rule. Along with the instructions from the business rule application on executing the business rule, the system server will use the user-defined parameters to determine whether an exception notification should be generated. The process then moves to step 225. In step 225, the system server receives, from the user, the parameters that the user defined in creating the business rule. The process moves to step 230.

In step 230, the system server executes the business rule. In so doing, the system server uses the instructions defined by the business application to perform the monitoring observation defined by the rule. The process moves to step 235. In step 235, the system server determines whether the business rule is event-triggered. A business rule is event-triggered if the business rule requires the system server to evaluate whether an event has occurred. For example, a market activity changed business rule is an event-triggered business rule. This rule requires the system server to determine whether the monitored event, i.e. a market activity such as a retail promotion, has occurred. It does this by evaluating event data that is stored in its local database by users who communicate such event occurrence, such as changing a store promotion, to the system server for evaluation. An event-triggered business rule is contrasted with a business rule that requires the system server to interrogate, or query, external databases to determine whether an externally-monitored parameter, or set of parameters, is in violation of the business rule. Such a business rule is an analytical rule and requires that control temporarily be passed to an application responsible for interrogating, or querying, the external databases for analytical data.

If the business rule is event-triggered, the process moves to step 250, otherwise the process moves to step 240. In step 240, the system server passes control to an external application that is responsible for interrogating the databases relevant to the execution of the specified business rule and sends the external application the associated business rule parameters. In step 245, the external application continues the execution of the business rule by interrogating the relevant databases and determining whether violations to the business rule have occurred. If violations have occurred, such as warehouse inventory being above or below a specified threshold, the external application generates a list of the applicable exception notifications and passes control back to the system server for delivery of the exception notifications to the appropriate users. The process then moves to step 255.

In step 250, the system server determines whether a triggering-event has occurred. The system server accomplishes this by investigating its associated database for specific triggering-events. A triggering-event is an event that the business rule requires the system server to determine whether it has occurred. Thus, the occurrence of the event triggers the generation of an exception notification to the appropriate users. The occurrence of such events may be communicated to the system server by the entity that caused the event's occurrence. For example, if a retailer runs or changes an in-store promotion, it will communicate this information to the system server at the beginning of the promotion or at the time the promotion is changed. After receiving notification of an event, the system server may store the information in its database for future processing. Thus, if the system server locates the event that is subject to monitoring in its database, it will determine that a triggering event has occurred. The process then moves to step 255.

In step 255, the system server determines whether a triggering-event and/or a violation of the business rule has occurred. If either has occurred, the process moves to step 260, otherwise the process moves to step 265. In step 260, the system server sends the generated exception notifications to the authorized users. The system server determines the list of authorized users by examining the subscription list maintained on the system server and/or system server database as well as examining the attributes of the item that caused the exception notification. For example, if a user's email address is either on the subscription list associated with a business rule monitoring shampoo inventory or is defined in an attribute of the shampoo that was out-of-stock, that user will receive an exception notification from the system server. The process then moves to step 265.

In step 265, the system server determines whether the business rule expired. In one embodiment of the invention, a business rule is executed for a limited duration. After that duration has expired, the system server will no longer execute the business rule unless requested again to do so. If the business rule has expired, the process moves to step 270 and ends, otherwise the process returns to step 230.

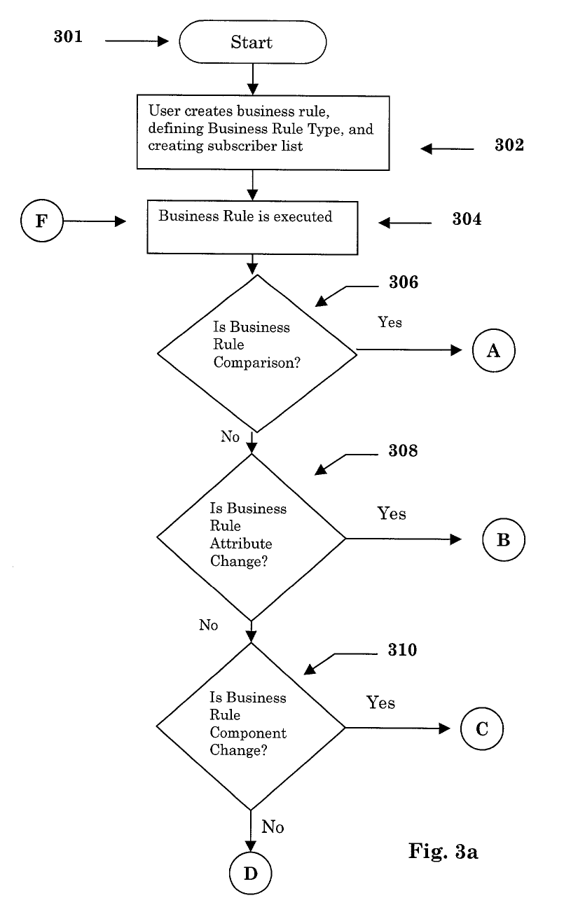

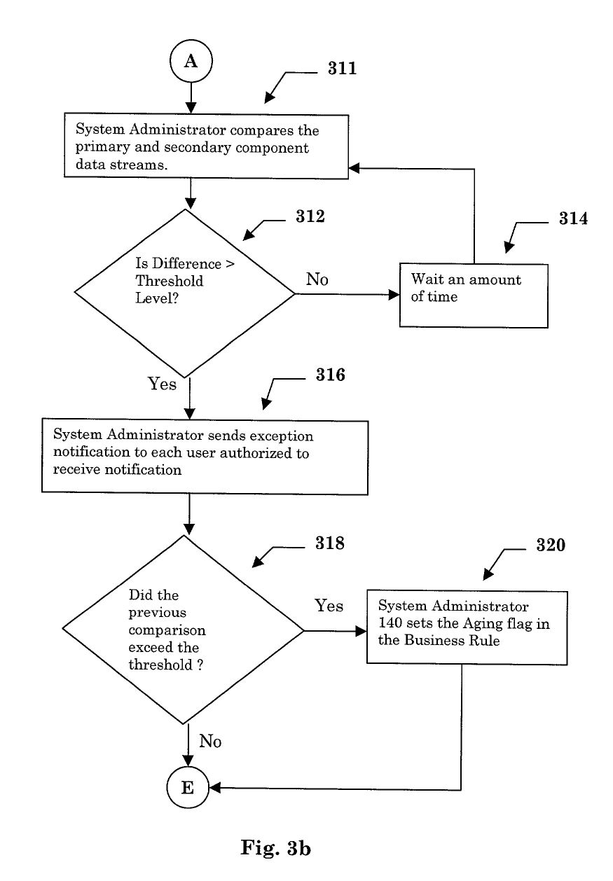

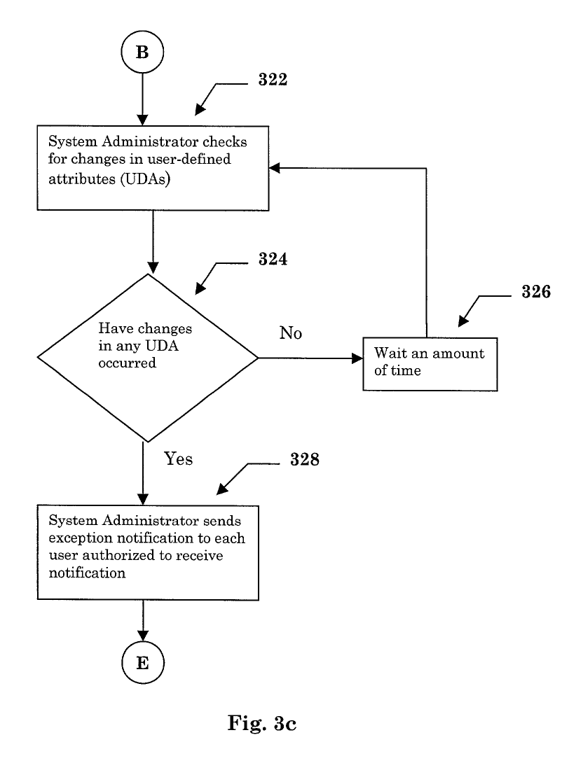

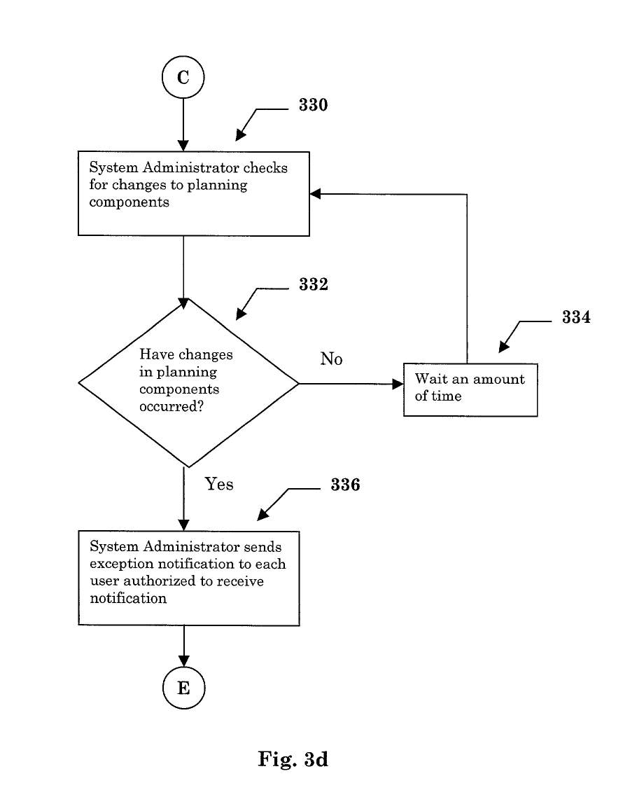

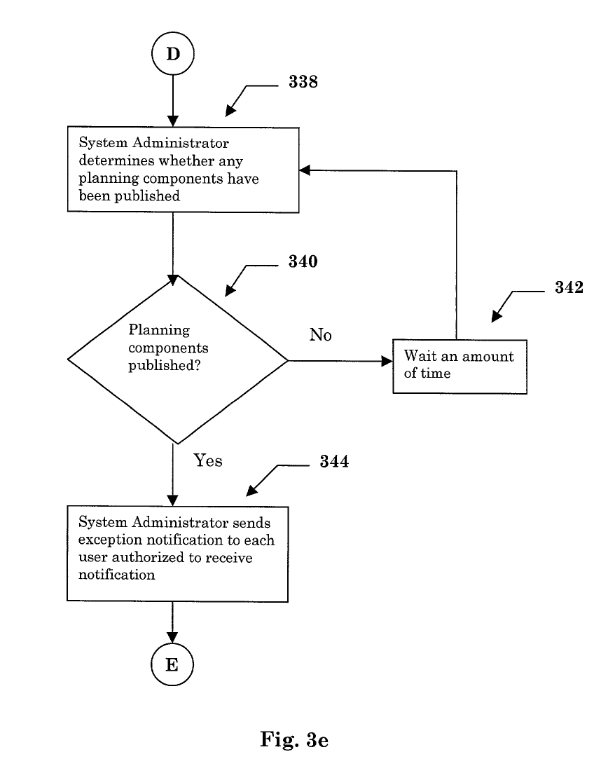

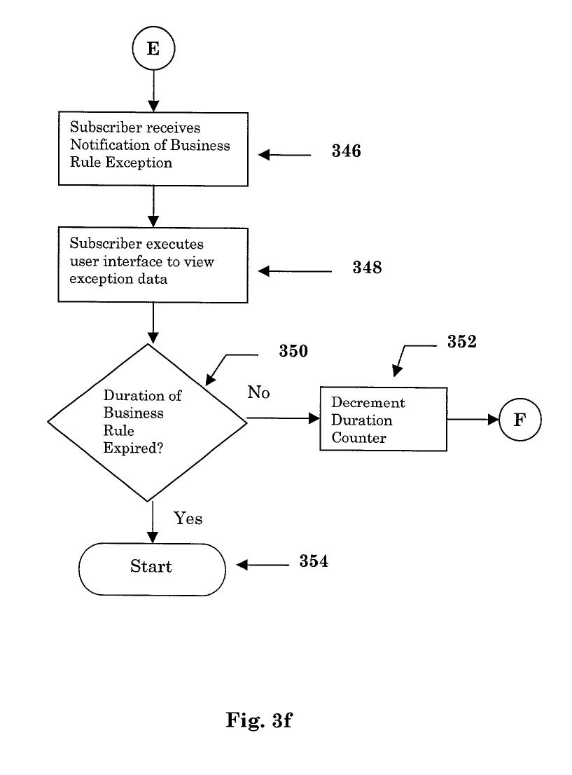

FIGS. 3a-f shows for illustrative purposes, the process for monitoring supply chain parameters for four specific business rules, viz., attribute change, comparison, planning component publish, and planning component change, in accordance with an embodiment of the invention. It should be noted, as shown with respect to FIG. 2, that any number of business rules may be executed in accordance with the invention.

In FIG. 3a, the process begins at step 301. In step 302, a user establishes a business rule, defines the business rule type, and creates a subscriber list. The user creates a business rule and defines its type by entering the appropriate parameter values through a graphical user-interface, or any other suitable interface, that is communicatively coupled to a monitoring system server.

The process then moves to step 304. In step 304, the subscriber or the monitoring system server executes the business rule. Executing the business rule causes the monitoring system server to perform the observation called for by the business rule, and will continue to periodically do so until the duration of the business rule has expired. The process then moves to step 306. In step 306, the monitoring system server determines whether the business rule type is a comparison. If the monitoring system server determines that the business rule type is a comparison rule type, the process moves to step 311, otherwise the process moves to step 308.

In step 308, the monitoring system server determines whether business rule type is an attribute change rule type. If the monitoring system server determines that the business rule type is an attribute change, the process moves to step 322, otherwise the process moves to step 310. In step 310, the monitoring system server determines whether the business rule type is a component change rule type. If the monitoring system server determines that the business rule type is a component change rule type, the process moves to step 330, otherwise the process moves to step 338.

Returning to step 311, as shown in FIG. 3b, the monitoring system server compares the primary and secondary component data streams. The process then moves to step 312 where the monitoring system server determines whether the difference between the primary and secondary component data streams is greater than a user-defined threshold level. If the difference between the primary and secondary component data streams is greater than the threshold level, the process moves to step 316, otherwise the process moves to step 314. In step 314, the monitoring system server waits an amount of time before returning to step 311 and comparing again the primary and secondary component data streams in step 310.

In step 316, the monitoring system server sends an exception notification to each subscriber that is authorized to receive it. The process then moves to step 318. In step 318, the monitoring system server determines whether the difference between primary and secondary component streams determined in the previous comparison, i.e., the comparison that preceded the current comparison, also exceeded the notification threshold. If the monitoring system server determined that the previous difference did exceed the notification threshold, the process moves to step 320, otherwise the process moves to step 346. In step 320, the monitoring system server sets an aging flag. The process then moves to step 346.

Returning to step 322, as shown in FIG. 3c, the monitoring system server compares the previous value of a user-defined attribute with its current value to determine whether any change in the UDA has occurred. In step 324, the monitoring system server determines whether any changes have occurred to the user-defined attribute. If any changes have occurred, the process moves to step 328, otherwise the process moves to step 326. In step 326, the monitoring system server waits an amount of time, before returning to step 322 and comparing again the previous and current values for the UDA. In step 328, the monitoring system server sends an exception notification to each user that is authorized to receive a notification. The process then moves to step 346.

Returning to step 330, as shown in FIG. 3d, the monitoring system server compares the previous value of a planning component to its current value. In step 332, the monitoring system server determines whether any changes to the planning component have occurred. If a change has occurred, the process moves to step 336, otherwise the process moves to step 334. In step 334, the monitoring system server waits an amount of time, before returning to step 330 and comparing again the previous and current values for the planning component in step 330. In step 336, the monitoring system server sends an exception notification to each user that is authorized to receive it. The process then moves to step 346.

Moving to step 338, as shown in FIG. 3e, the monitoring system server checks whether any planning components have been published. Components are published when other users are able to view them. A user may publish a planning component via either a user interface or a batch process. The planning items that are published may create exception events themselves. That is, the component publish business rule may use the event data from a component being published to determine whether an alert should be sent. In step 340, the monitoring system server determines whether any of the planning components have been published. If any have been published, the process moves to 344, otherwise the process moves to step 342. In step 342, the monitoring system server waits an amount of time, before returning to step 338 and checking again whether any planning components have been published in step 338. In step 344, the monitoring system server 140 sends an exception notification to each subscriber that is authorized to receive a notification. The process then moves to step 346.

In step 346, the qualified subscriber, or user listed as an attribute of the item or event being monitored, receives the exception notification from the monitoring system server. In step 348, the user executes a user-interface to view the exception data. In step 350, the monitoring system server determines whether the business rule duration has expired. If the business rule has not yet expired, the process moves to step 352, otherwise the process moves to step 354. In step 352, the monitoring system server decrements a duration counter before returning to step 304 to execute the business rule. In step 354, the process concludes.

In addition to the notification process, the system herein allows the monitoring system server to notify subscribers if an exception has not been resolved within a specified period of time. This process is known as escalation and allows the subscriber to define the number of days that may elapse between when an exception is created and when the monitoring system server will execute a command-line batch process called notify. Each time the notify process is executed, the monitoring system server examines the amount of time the existing exceptions have existed and compares this time with the value in the delay parameter for any escalation levels that exist. If the exception has existed longer than the value of the escalation's delay parameter, notifications are sent to qualified subscribers.

Thus, a check is made for escalation levels whose delay parameter equals or is less than the difference between the original creation date of the exception and the run date of the notify process. For all such levels, a notification e-mail is sent to qualified subscribers. These notifications are not resent when later comparisons of the exception date against the run date for notify are made. Business rules that utilize escalation notification levels require a special attribute called the notification data type. The notification data type should indicate a valid user name or a valid e-mail address where the notifications are to be sent.

In accordance with one embodiment of the invention, the exception notifications for violations of business rules occur in several different cases, or types, that indicate differing violations. For example, the business rule may be defined to generate an exception notification when a supply chain attribute varies from a desired goal by more than an allowed value or by more than an allowed percentage deviation, when the supply chain attribute is changed, when a planning item is changed, or when a component of a business rule is either changed or published. There are therefore a number of various fields that the users 110 may modify in order to establish a business rule.

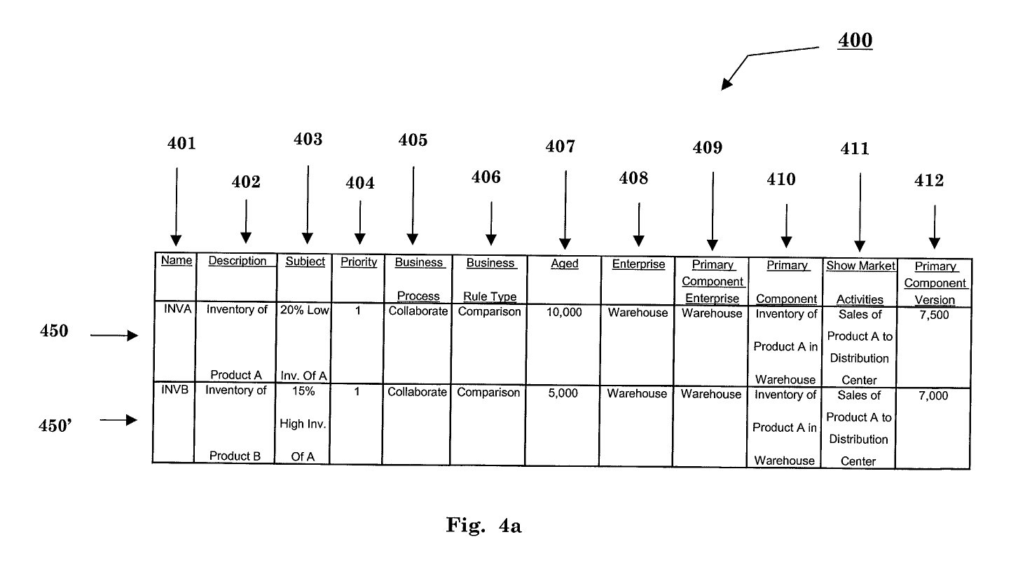

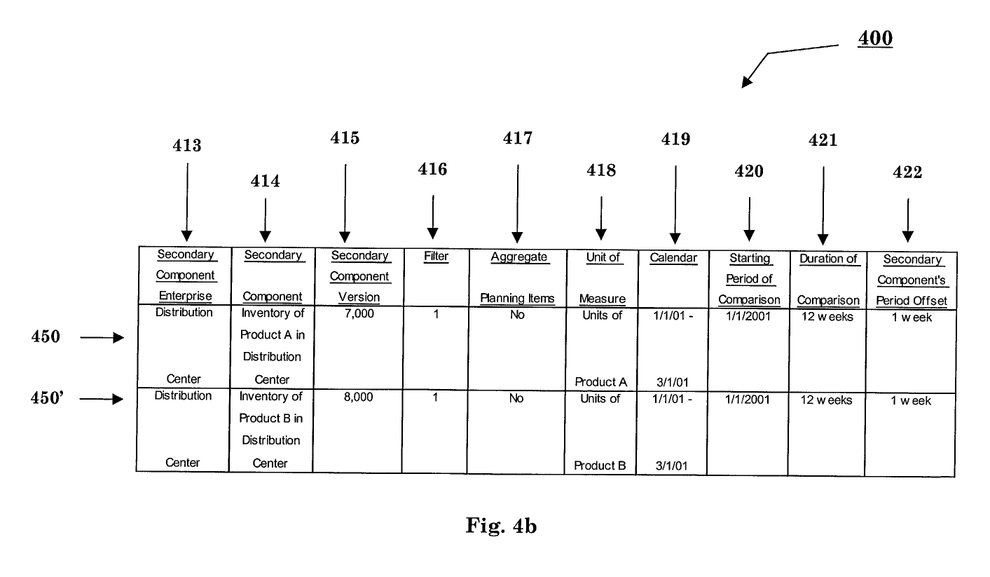

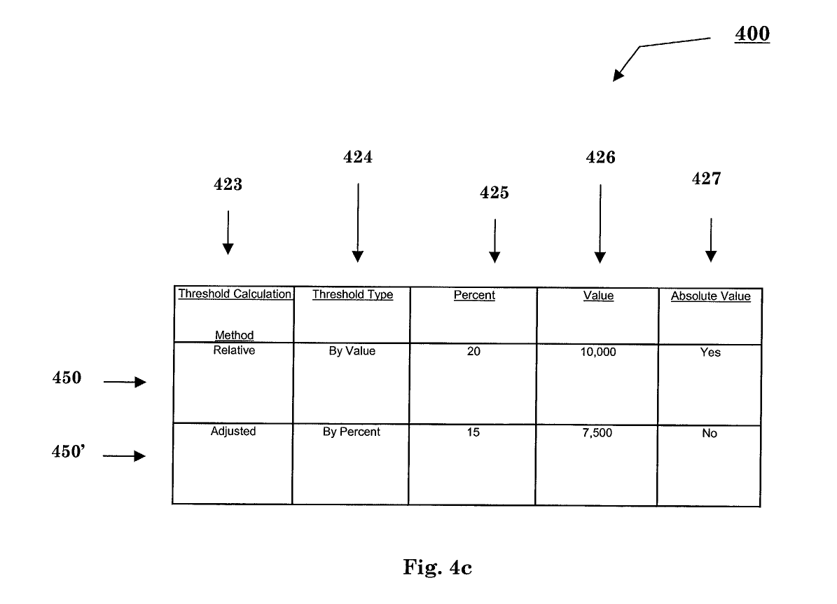

FIGS. 4-10 show, for illustrative purposes only, specific fields that a user 110 may modify when establishing pre-defined business rules in accordance with one embodiment of the invention. Of course, any number of business applications could be created and written that would allow for any number of business rules to be established. Therefore, the following figures are merely examples of business rule data fields that could be used with a particular business field application. For example, FIG. 4 shows the data fields that a user 110 may modify when establishing a comparison business rule for execution by the monitoring system server 140. After establishing a business rule, the user 110 sends the entered values of these fields to the monitoring system server 140, which then executes the business rule. Furthermore, FIGS. 4a-c show, for illustrative purposes only, records 450 and 450′, which are examples of values for each of the fields contained in the comparison business rule record.

According to one embodiment of the invention, the business rules available for execution include, but are not limited to, attribute change, comparison, component change, component publish, planning item change, market activity change, and planning items assigned/unassigned. For illustrative purposes only, the disclosure discusses the function of each of the above pre-defined business rules before presenting their associated data fields.

An exception notification will be generated for violations of an attribute change business rule when changes to a user-defined attribute (UDA) are detected by the monitoring system server 160. A UDA is a supply chain variable that the user 110 specifically requests the monitoring system server 160 to monitor during the creation of the business rule. An exception notification will be generated for violations of a comparison business rule if the variance between two supply parameter data streams exceeds a pre-defined threshold level. A violation of the component change rule occurs if a change occurs to a planning component that the monitoring system server 160 is monitoring.

An exception notification will be generated for violations of a comparison business rule whenever the difference between two planning component streams exceeds a specified threshold, either by value or percentage. The monitoring system server 140 executes a comparison business rule by comparing two planning component data streams and generates an exception, if necessary. The component data streams that are compared by the monitoring system server 140 during the execution of the comparison business rule may include data specific to the user 110 who generated the business rule as well as data that have been shared between users 110 and/or non-subscribing entities 160 via a partnership.

An exception notification will be generated for violations of a planning component change business rule when changes to a planning component, or associated item, are detected by the monitoring system server 160. Such changes include, but are not limited to, adding new, modifying existing, or deleting existing planning items. A planning component is time series data (e.g., data based on monthly, yearly, daily, etc. periods). A planning item is an entity or item that has a planning component associated with it. Attributes may be utilized to define a planning item. At least two attributes, a location and a product attribute, may be assigned to a planning item. In addition, UDAs may be assigned to a planning item. The relationship between planning item, attributes and planning components may be best illustrated with the following example. Suppose a warehouse in Tacoma, Wash. is storing and shipping shampoo in 8 oz. sizes. In this situation, you will have a planning item with attributes of “shampoo” for the product attribute, “Tacoma, Wash.” for the location attribute, and perhaps “8 oz.” for a user defined attribute. Associated with that planning item will be different time series data called planning components. One planning component could be a forecast data, while another could be for actual customer orders, while another could be promotional expenses, where all of the data are related to “8 oz. shampoo in Tacoma, Wash.”

Components available for selection by this business rule include the owner enterprise components and any components that have been shared, both draft and published, via a supply-chain partnership. A violation of a components publish business rule generates an exception notification if the specified planning component is published. In accordance with one embodiment of the invention, publishing refers to making the planning component available for viewing by those who have been granted permission to view that particular data. The owner of a particular planning item can authorize others to view the data. Thus, publishing the data triggers the ability of permitted users to view the data.

An exception notification will be generated for violations of a market activity change business rule when changes to a market activity are detected by the monitoring system server 160. These changes include, but are not limited to, any update activities such as creating, editing, copying, and deleting a market activity. A market activity is a promotion that is run or sponsored by a supply chain partner such as the supplier, manufacturer, or retailer. For example, one market activity contemplated by the invention is a temporary price reduction (TPR). A TPR occurs when a manufacturer offers a discount to a retailer on a specific model of an item that the manufacturer discontinuing. The retailer then passes this discount on to the end consumer by offering a TPR on the discontinued item. Other types of market activities include, but are not limited to, 2 for 1, newspaper ads, store front displays, and special packaging promotions. A change to a market activity occurs therefore whenever the retailer or promoter changes the offered promotion. For example, a retailer may be offering a limited-time discount of 20%, but later changes the price discount to 30%. The later discount may then be an event that triggers an event notification.

An exception notification will be generated for violations of the planning items assigned/unassigned business rule whenever a planning item is assigned to a market activity by either the user 110 or the monitoring system server 160. A planning item is assigned to a market activity whenever that item becomes associated with the market activity or promotion that is defined in the business rule. For example, if a particular stereo is assigned to the above 20% promotion, this event could generate an exception notification to the planning items assigned/unassigned business rule.

FIG. 4a shows, for illustrative purposes only, twelve of twenty-six fields 400 that a user 110 may modify when establishing a comparison business rule. When executing a comparison business rule, the monitoring system server 140 compares the data stream represented by a primary component data field with that represented by a secondary component data field. The comparison is made over a time period specified in a calendar data field, for a length of time specified in a duration data field, and with an offset in the starting point of comparison between the two data streams specified in an offset data field.

Specifically, FIG. 4a shows a name field 401, a description field 402, a subject field 403, a priority field 404, a business process field 405, a business rule type field 406, an aged field 407, an enterprise field 408, a primary component enterprise field 409, a primary component field 410, a show market activities field 411, and a primary component version field 412. Name field 401 contains the name given to the business rule to identify it from other comparison business rules. Description field 402 contains a free-form text description of the business rule. Subject field 403 contains the information that will appear in the subject line of notifications that are sent to subscribers.

Priority field 404 contains the priority value assigned to the comparison business rule. Most priority values are based upon the criticality of the exceptions that the business rule generates. Thus, the subscriber defining the business rule may rank the level of importance of the business rule by either increasing or decreasing the value stored in this field. Users 110 who receive exception notifications from violations of a business rule may thusly rank the exception accordingly. This feature allows users 110 to view and resolve critical exceptions before those of lesser importance.

Additionally, a user may customize the delivery mechanism of the exception alert notification based on the priority that the subscriber assigns to the business rule. Thus, a user may customize business rules to have violations of the rule sent to different locations depending on the priority of the business rule. For example, by defining the business rule as being of critical priority, a user may require that violations of the rule, and all other rules defined as critical, be sent to the subscriber's pager in small-text format for immediate attention. Small text format provides a summary of the violation without its complete data being presented. Similarly, a user may require that exception notifications for violations of business rules defined as being of high priority be sent to a cell phone or a PDA in a medium HTML format. Medium HTML format provides the user with more information than the small text format, but is also presented without the complete data of the violation. A user may also require that exception notifications for violations of business rules defined as being of low priority be sent to an e-mail address in fall HTML format. Full HTML format provides the subscriber with the complete data associated with the business rule violation. It should be understood by those who are skilled in the art that the actual priorities available to a user are not limited to “critical”, “high”, or “low”; but rather are customizable by the client's implementation of the invention.

Business process field 405 contains the process to which the business rule belongs. Business rule type field 406 contains the business rule type. Aged field 407 contains a flag indicating whether the two current sets of component data being compared have previously exceeded the threshold criteria of the comparison business rule. Enterprise field 408 contains the name of the enterprise that generated, or owns, the comparison business rule. Primary component enterprise field 409 contains the name of the enterprise that owns the primary data component used for the comparison. Primary component field 410 contains the name of the primary component used in the comparison business rule. Show market activities field 411 contains market activity components in the primary or secondary component selection lists. Primary component version field 412 contains the current value of the primary component that is to be compared against the secondary component value.

FIG. 4b shows ten of twenty-three fields 400 that a user 110 may modify when establishing a comparison business rule. Specifically, FIG. 4b shows a secondary component enterprise field 413, a secondary component 414, a secondary component version field 415, a filter field 416, an aggregate planning items field 417, a unit of measure field 418, a calendar field 419, a starting period of comparison field 420, a duration of comparison 421, and a secondary component's period offset field 422. Component enterprise field 413 contains the name of the enterprise that owns the secondary data component. Secondary component field 414 contains the value of the secondary data component that is compared against the primary data component. Secondary component version field 415 contains the value of the secondary component that will be used in the comparison. Filter field 416 contains the filter that is used to return the set of planning items. Aggregate planning items field 417 contains a flag indicating whether the totals of the component planning items should be aggregated. Unit of measure field 418 contains the units of measurement for the comparison. Calendar field 419 contains the calendar that will be used for the comparison. Starting period of comparison field 420 contains the time bucket that will be used for the start of the comparison. Duration of comparison field 421 contains the number of periods that should be compared. Secondary component's period offset field 422 contains the time bucket in the secondary component that will be used to start the comparison against the primary component.

FIG. 4c shows, for illustrative purposes, four of twenty-three fields 200 that a user 110 may modify when establishing a comparison business rule. Specifically, FIG. 4c shows a threshold calculation method field 423, a threshold type field 424, a percent field 425, a value field 426, and an absolute field 427. Threshold calculation method field 423 contains a variable indicating whether the user 110 that created the comparison business rule, i.e., the business rule owner, would like the monitoring system server 140 to use either an adjusted variance or a relative variance percentage calculation method. If the user 110 that creates the business rule, i.e. the owner of the business rule, selects an adjusted variance, the variance between the primary and secondary component will be identical regardless of which component is larger. If the owner of the business rule selects relative variance, the variance will vary depending on which value is larger. Threshold type field 424 contains the type of comparison threshold that monitoring system server 140 will use for the comparison. Available values for this field incorporated within the present invention include, but are not limited to: “by both”, “by either”, “by value”, and “by percent.” Percent field 425 contains the threshold percentage that is to be used in the comparison. If the business rule owner requested that the comparison type include a percentage comparison, the monitoring system server will use the value of this field to determine whether the difference between the values of the primary and secondary components exceeds the allowable percentage variance. Value field 426 contains the threshold value to be used in the comparison. If the business rule owner requested that the comparison type include a value comparison, the monitoring system server will use the value of this field to determine whether the difference between the values of the primary and secondary components exceeds the allowable absolute or value variance. Absolute field 427 contains a flag indicating whether both positive and negative integers may be returned as exception values.

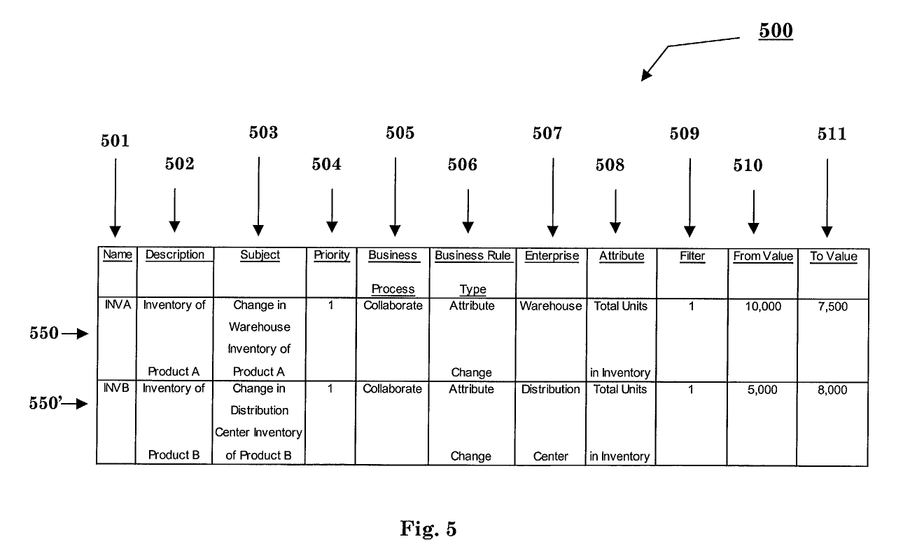

FIG. 5 shows the fields 500 that the user 110 may modify when establishing an attribute change business rule. When executing an attribute change business rule, the monitoring system server 140 determines whether a change has occurred to a specified supply-chain parameter, or user-defined attribute (UDA) by comparing the previous value of the attribute stored in a from value data field, with its current value, stored in a to value data field. A UDA is a supply-chain parameter that is requested to be monitored by the user 110 that created the business rule. Thus, the monitoring system server 140 sends eligible users 110 exception notices whenever a UDA is changed.

Users 110 who are members of an escalation level also receive exception notices. Escalation levels define a classification of separate notification levels. For each escalation level, the user 110 may define the number of days that may elapse between when an exception is created and when the exception is resolved, i.e. the age of the exception. When the business rule is defined, the user is asked if the rule supports aging. If so, then an escalation path is also created along with selecting the business rule type. This includes the levels of notification as well as the delay (in days) between the levels. The levels are defined via a special UDA type called notification.

For example, one or more notification UDAs may be added to the planning item table to represent the planner, product manager, manufacturing manager, and logistics manager. The actual data in these columns can then either be user ID within the system if the user is a subscriber of the solution, or an external e-mail address if the user is a non-subscriber 160. Then when a business rule creates an exception (the two forecasts exceed the rules threshold), the associated planner (or whoever is first in the escalation list) is sent the e-mail. If no one resolves this issue within each of the following escalation intervals, then each person is notified in turn. Each application that uses the disclosed invention is responsible for defining how the escalation path is determined.

FIG. 5 shows a name field 501, a description field 502, a subject field 503, a priority field 504, a business process field 505, a business rule type 506, an enterprise field 507, an attribute field 508, a filter field 509, a from value field 510, and a to value field 511. As with a comparison business rule, the owner must also specify the appropriate permissions during the creation of the business rule. Records 550 and 550′ show, for illustrative purposes only, examples of values for each of the fields contained in an attribute change business rule record. Name field 501 contains the name given to the business rule to identify it from other business rules. Description field 502 contains a free-form text description of the business rule. Subject field 503 contains the information that will appear in the subject line of notifications that are sent to subscribers. Priority field 504 contains the priority value assigned to the attribute change business rule. Most priority values are based upon the criticality of the exceptions that the business rule generates, as detailed above. Business process field 505 contains the process to which the Business Rule belongs. Business rule type field 506 contains the business rule type. Enterprise field 507 contains the name of the enterprise that generated, or owns, the attribute change business rule. Attribute field 508 contains the units of measurement for the attribute. Filter field 509 contains the filter that the monitoring system server 140 will use to return a set of planning items for the business rule. From value field 510 contains the original value of the UDA. To value field 510 contains the value to which the UDA was changed.

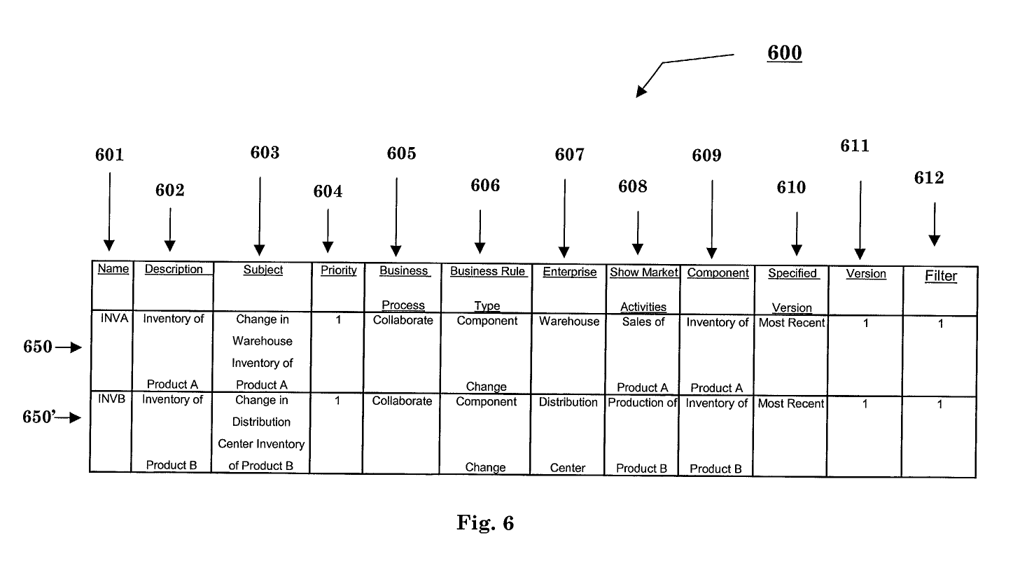

FIG. 6 shows the fields 600 that a user 110 may modify when establishing a component change business rule. When executing this business rule, the monitoring system server 140 will generate an exception notification whenever a change in a specific component data stream occurs. Specifically, FIG. 6 shows a name field 601, a description field 602, a subject field 603, a priority field 604, a business process field 605, a business rule type 606, an enterprise field 607, a show market activities field 608, a component field 609, a specified version field 610, a version field 611, and a filter field 612. Records 650 and 650′ show, for illustrative purposes only, examples of values for each of the fields contained in the business rule record. Name field 601 contains the name given to the business rule to identify it from other business rules. Description field 602 contains a free-form text description of the business rule. Subject field 603 contains the information that will appear in the subject line of notifications that are sent to subscribers. Priority field 604 contains the priority value assigned to the business rule. Most priority values are based upon the criticality of the exceptions that the business rule generates, as detailed above. Business process field 605 contains the process to which the business rule belongs. Business rule type field 606 contains the business rule type. Enterprise field 607 contains the name of the enterprise that generated, or owns, the business rule. Show market activities field 608 contains the market activity components in the component selection list. Component field 609 contains the name of the component that is monitored for changes. Only the components specific to the subscriber accessing the business rule are available. Specified version field 610 contains the variable that is used to indicate that a particular version of the specified component is to be monitored for changes. Version field 611 contains the number of the specified version. Filter field 612 contains the name of the filter that will be used by the monitoring system server 140 to return a set of planning items. Only filters that are owned by the user 110 that generated the business rule are available.

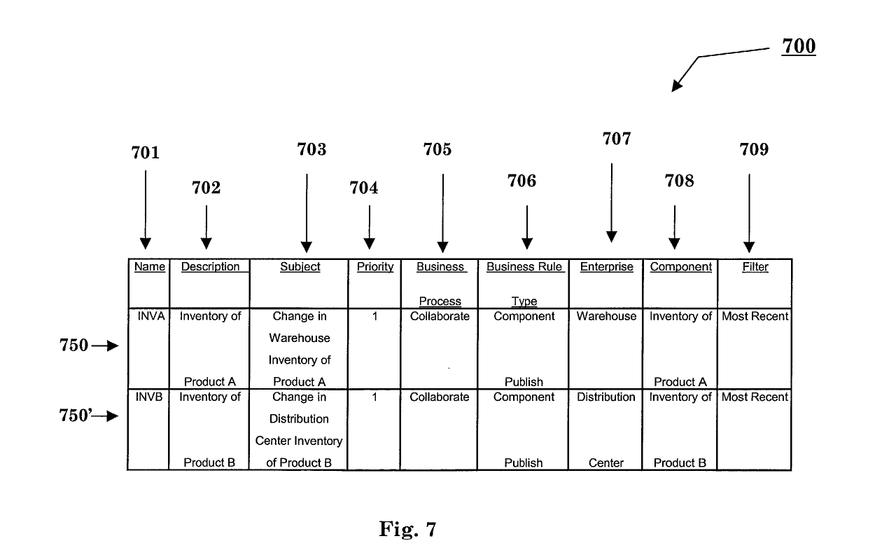

FIG. 7 shows the fields 700 that a user may modify when establishing a component publish business rule. When executing a component publish business rule the monitoring system server 140 determines whether a supply-chain component, identified in a component data field, has been published. The supply-chain components available for selection under this business rule included the enterprise owner of the business rule and any components that are shared via a partnership with them, either shared or secured. Specifically, FIG. 7 shows, for illustrative purposes, a name field 701, a description field 702, a subject field 703, a priority field 704, a business process field 705, a business rule type field 706, an enterprise field 707, a component field 708, and a filter field 709. Records 750 and 750′ show, for illustrative purposes, examples of values for each of the fields contained in a comparison business rule record. Name field 701 contains the name given to the business rule to identify it from other business rules. Description field 702 contains a free-form text description of the business rule. Subject field 703 contains the information that will appear in the subject line of notifications that are sent to subscribers. Priority field 704 contains the priority value assigned to the component publish business rule. Most priority values are based upon the criticality of the exceptions that the business rule generates, as detailed above. Business process field 705 contains the process to which the business rule belongs. Business rule type field 706 contains the business rule type. Enterprise field 707 contains the name of the enterprise that generated, or owns, the component publish business rule. Component field 708 contains the name of the component that is monitored by the monitoring system server 140. Only the components belonging to the user 110 that is executing the business rule are available. Filter field 709 contains the name of the filter that will be used by the monitoring system server 140 to return a set of planning items. Only filters that are owned by the user 110 that generated the business rule are available.

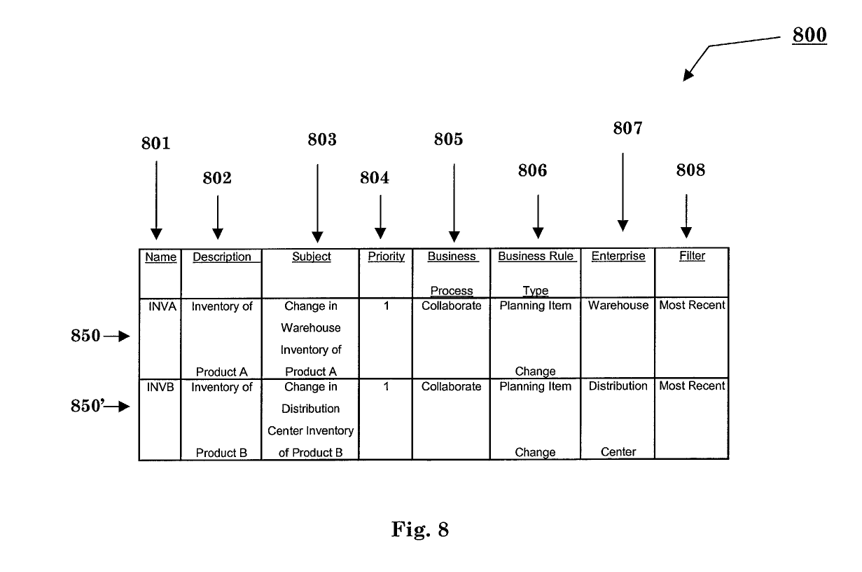

FIG. 8 shows, for illustrative purposes, the fields 800 that a user 110 may modify when establishing a planning items change business rule. Such changes include, but are not limited to adding new planning items as well as modifying existing, or deleting existing planning items. When executing a planning item changed business rule, the monitoring system server 140 generates an exception notification if the specified planning item is changed. Specifically, FIG. 8 shows a name field 801, a description field 802, a subject field 803, a priority field 804, a business process field 805, a business rule type field 806, an enterprise field type 807, and a filter field 808. Records 850 and 850′ show, for illustrative purposes, examples of values for each of the fields contained in a planning item change business rule record. Name field 801 contains the name given to the business rule to identify it from other business rules. Description field 802 contains a free-form text description of the business rule. Subject field 803 contains the information that will appear in the subject line of notifications that are sent to subscribers. Priority field 804 contains the priority value assigned to the business rule. Most priority values are based upon the criticality of the exceptions that the business rule generates, as detailed above. Business process field 805 contains the process to which the business rule belongs. Business rule type field 806 contains the business rule type. Enterprise field 807 contains the name of the enterprise that generated, or owns, the planning item change business rule. Filter field 808 contains the name of the filter that will be used by the monitoring system server 140 to return a set of planning items. Only filters that are owned by the user 110 that generated the business rule are available.

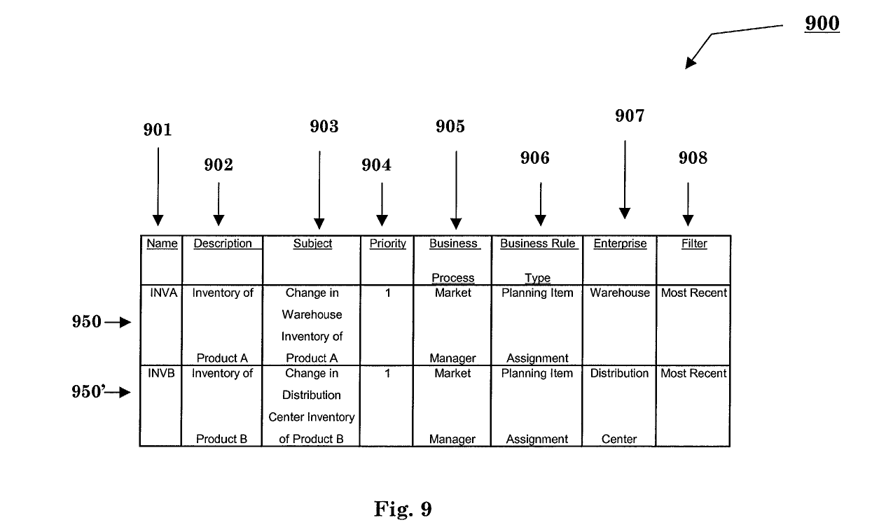

FIG. 9 shows, for illustrative purposes, the parameters that a user 110 may modify when establishing a planning items assignment business rule. When executing a planning items assignment business rule, the monitoring system server 140 generates an exception notification if the specified planning item has been either assigned, or unassigned, to a market activity. A planning item is assigned, or unassigned, to, or from, a market activity by a separate application that manages market activity. Specifically, FIG. 9 shows a name field 901, a description field 902, a subject field 903, a priority field 904, a business process field 905, a business rule type field 906, an enterprise field type 907, and a filter field 908. Records 950 and 950′ show, for illustrative purposes, examples of values for each of the fields contained in a planning item assignment business rule record. Name field 901 contains the name given to the business rule to identify it from other business rules. Description field 902 contains a free-form text description of the business rule. Subject field 903 contains the information that will appear in the subject line of notifications that are sent to subscribers. Priority field 904 contains the priority value assigned to the business rule. Most priority values are based upon the criticality of the exceptions that the business rule generates, as detailed above. Business process field 905 contains the process to which the business rule belongs. Business rule type field 906 contains the business rule type. Enterprise field 907 contains the name of the enterprise that generated, or owns, the planning item change business rule. Filter field 908 contains the name of the filter that will be used by the monitoring system server 140 to return a set of planning items. Only filters that are owned by the user 110 that generates the business rule are available.

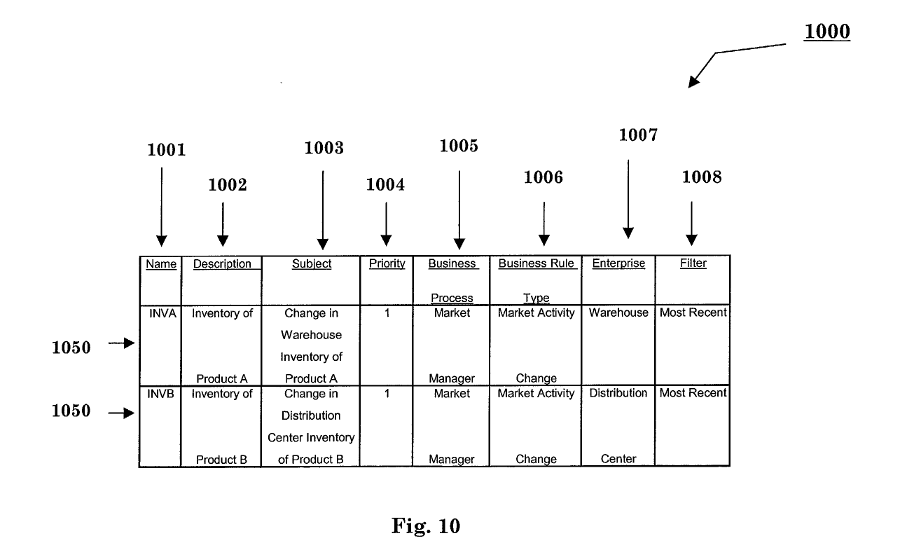

FIG. 10 shows, for illustrative purposes, the fields 1000 that a user 110 may modify when establishing a market activity change business rule. When executing a market activity change business rule, the monitoring system server 140 generates an exception notification if any market activities have been changed. Changes for which the monitoring system server 140 searches include, but are not limited to, creation, updating, copying, and deleting the monitored market activity. Specifically, FIG. 10 shows a name field 1001, a description field 1002, a subject field 1003, a priority field 1004, a business process field 1005, a business rule type field 1006, an enterprise field type 1007, and a filter field 1008. FIG. 8 also shows, for illustrative purposes, records 1050 and 1050′, which are examples of values for each of the fields contained in a market activity change business rule record. Name field 1001 contains the name given to the business rule to identify it from other business rules. Description field 1002 contains a free-form text description of the business rule. Subject field 1003 contains the information that will appear in the subject line of notifications that are sent to subscribers. Priority field 1004 contains the priority value assigned to the business rule. Most priority values are based upon the criticality of the exceptions that the business rule generates, as detailed above. Business process field 1005 contains the process to which the business rule belongs. Business rule type field 1006 contains the business rule type. Enterprise field 1007 contains the name of the enterprise that generated, or owns, the market activity changed business rule. Filter field 1008 contains the name of the filter that will be used by the monitoring system server 140 to return a set of market activities. Only filters that are owned by the user 110 that generated the business rule are available.

Comparison Business Rule Example

By way of example, and for illustrative purposes only, the following is an example of the execution of a comparison business rule in accordance with an embodiment of the invention. Referring to elements of FIGS. 1 and 2a-c, the process begins when the monitoring system server 140 examines the calendar field 219 of the business rule to determine the relevant periods of observation. Each calendar represented by the calendar field 219 has a finite number of periods, which are determined by the calendar's periodicity as well as the calendar's start and end date. A calendar's period extends forward, and backward, in time from the starting period of comparison, stored in the comparison field 220. The period that contains the calendar's start date is always labeled “Period 1.” The number of periods in a calendar is determined from the calendar's end date and the calendar's periodicity type (i.e., “daily,” “monthly,” or “custom”).

Business rule periods are based on the selected calendar's periods. Thus, business rule periods also extend forward and backward in time from the starting period of comparison. If a “Period 0” exists, the values of the duration field 221 and the offset value for the comparison are affected. Furthermore, data may not be changed within a “freeze” period. A freeze period duration is determined by finding the calendar period that contains the starting period 220, and then freezing a certain number of periods beyond that value in the calendar period field 219. The number of periods to be frozen is determined by the value of the duration field 221 that was entered into the component fields during the creation of the business rules.

For illustrative purposes only, the first three days of every planning cycle are defined as a freeze period for a planning component A, and that the first five days of every planning cycle may be defined as a freeze period for a planning component B. The monitoring system server 140 determines the number of periods over which the planning components will be compared. For illustrative purposes only, assume that the user 110 that defined the comparison business rule entered a value of “7” in the duration field 22, establishing seven periods for comparison.

The monitoring system server 140 next determines the offset between the start period in planning component A and the first period in planning component B where the comparison is to start. For illustrative purposes only, assume that the start period for planning component A is Period 3 and that start period for planning component B is Period 5. Thus, the monitoring system server 140 would determine the offset to have a value of 2.

It should be noted that duration and offset are distinguishable. The value of the duration field 221 is the number of business rule periods over which the monitoring system server 140 will execute the comparison business rule. Offset is the period at which the comparison begins in the secondary planning component, here planning component B. Thus, to compare Period 0 of planning component A against Period 0 of planning component B, an Offset value of 0 is used. Also, to compare Period 1 of planning component A against Period 2 of planning component B, an Offset value of 1 is used. If the value of the duration field 221 for the comparison business rule exceeds the number of periods available for the comparison, the monitoring system server 140 will compare as many periods as is possible when the business rule is executed.

There may be circumstances when the periods for two planning components are compared and the data value for the secondary planning component is larger than the data value for the primary planning component, thus yielding a negative value during the comparison. Unless the user 110 that defined the comparison business Rule selected the “Absolute” feature, a negative difference will not be reported. To ensure that exception notifications are generated for negative values, the user 110 that generated the comparison business rule must therefore select the “Absolute” feature when defining the business rule.

Finally, if the user 110 that generated the business rule selected an “Adjusted Method” of comparison, the comparison will always yield the same variance, either positive or negative, regardless of whether the primary component is larger or smaller than the secondary component. If, however, the user 110 selected a “Relative Method,” the variance will vary depending on whether the primary component is larger or smaller than the secondary component.

It will be apparent to those skilled in the art that various modifications and variations may be made to the system and method of monitoring supply-chain management methodology without departing from the spirit or the scope of the invention. Thus, it is intended that the present invention cover the modifications and variations of this invention, provided that they come within the scope of any claims and their equivalents.

What is claimed is:

1. A method for monitoring supply chain information in a supply chain network comprising:
establishing at least one business rule;
executing the at least one business rule;
generating at least one exception notification for a violation of the at least one business rule; and
sending the at least one exception notification to at least one user.

2. The method according to claim 1, wherein the step of establishing at least one business rule includes:
selecting at least one business rule; and
providing at least one parameter corresponding to the selected business rule.

3. The method according to claim 1, wherein the step of establishing at least one business rule includes creating a customized business rule having at least one associated parameter.

4. The method according to claim 1, wherein the business rule includes a set of instructions for monitoring supply chain data.

5. The method according to claim 1, wherein the step of establishing a business rule includes defining a subscriber list.

6. The method according to claim 5, wherein the subscriber list includes a list of users authorized to receive the at least one exceptions notification.

7. The method according to claim 1, wherein the business rule is at least one of an attribute change type, a comparison type, a component change type, a component publish type, a planning item change type, a market activity change type, and a planning items assigned/unassigned type.

8. The method according to claim 1, wherein the executing step includes:
evaluating supply chain information corresponding to the established at least one business rule and an at least one parameter;
determining a violation of the at least one business rule based upon the evaluated supply chain information.

9. The method according to claim 8, wherein the evaluating step includes analyzing at least one event-based parameter to determine the occurrence of an event.

10. The method according to claim 9, wherein analyzing at least one event-based parameter includes executing a business rule that is at least one of an attribute change type, a component change type, a component publish type, a planning item change type, a market activity change type, and a planning items assigned/unassigned type.

11. The method according to claim 8, wherein the evaluating step includes querying at least one supply chain information database.

12. The method according to claim 11, wherein querying at least one supply chain information database includes executing a business rule that is a comparison type.

13. The method according to claim 8, wherein the step of determining a violation of the at least one business rule includes
monitoring a primary and a secondary business variable;
calculating a variance between the primary and secondary business variable; and
determining whether the variance is greater than a threshold level.

14. The method according claim 1, wherein the step of sending the at least one exception notification includes delivering the notification via at least one of an e-mail transmission, a cellular transmission, or a satellite transmission.

15. A system for monitoring supply chain information, comprising:
at least one user interface for establishing a business rule; and
a monitoring system server in communication with the at least one user interface, the monitoring system server executing the business rule received from the user interface.

16. The system according to claim 15, wherein the monitoring system server further monitors supply chain information correlating to the selected business rule.

17. The system according to claim 16, wherein the monitoring system server generates at least one exception notification for a violation of the selected business rule.

18. The system according to claim 17, wherein the monitoring system server sends the at least one exception notification to the at least one user interface.

19. The system according to claim 15, further including a monitoring application communicatively coupled to the monitoring system server and the at least one user interface, the monitoring application monitoring supply chain information in accordance with at least one user-defined parameter.

20. A system for monitoring supply chain information comprising:
establishing means for establishing at least one business rule;
executing means for executing the at least one business rule;
generating means for generating at least one exception notification for a violation of the at least one business rule; and
transmission means for transmitting the at least one exception notification to users.

21. A computer program product comprising a computer useable medium having computer readable code embodied thereon, the computer program product adapted to effect the steps comprising:
establishing at least one business rule;
executing the at least one business rule;
generating at least one exception notification for a violation of the at least one business rule; and
sending the at least one exception notification to at least one user.
